(19) United States
(12) Patent Application Publication
(10) Pub. No.: US 2022/0363264 A1
(43) Pub. Date: Nov. 17, 2022

(54) ASSESSING DRIVER COGNITIVE STATE

(71) Applicant: INTERNATIONAL BUSINESS MACHINES CORPORATION, ARMONK, NY (US)

(72) Inventors: Erhan Bilal, Westport, CT (US); Bo Wen, New York, NY (US); Nicholas Andrew Barra, White Plains, NY (US); JEFFREY L. ROGERS, Briarcliff Manor, NY (US); Bing Dang, Chappaqua, NY (US); TIAN HAO, White Plains, NY (US)

(21) Appl. No.: 17/302,869

(22) Filed: May 14, 2021

(51) Int. Cl. B60W 40/08; B60W 50/14; B60W 10/04; B60W 10/18; B60W 10/20

(52) U.S. Cl. CPC B60W 40/08; B60W 50/14; B60W 10/04; B60W 10/18; B60W 10/20; H04L 67/125

(57) ABSTRACT

A method, a structure, and a computer system for assessing a cognitive state of a driver of a vehicle. The exemplary embodiments may include collecting data from one or more sensors positioned around the vehicle and calculating a distraction value, an engagement value, and a workload value corresponding to the driver of the vehicle based on the data. The exemplary embodiments may further include determining whether the driver exhibits a low cognitive state based on the distraction value and the engagement value, and, based on determining that the driver exhibits the low cognitive state, assuming control of the vehicle.

### BACKGROUND

The exemplary embodiments relate generally to cognitive state assessment, and more particularly to assessing the cognitive state of a driver of a vehicle.

Every year, the National Highway Traffic Safety Administration conducts crash tests on new vehicles and rates their performance in its 5-Star Safety Rating program. To pass this test, vehicle manufacturers equip cars with passive safety feature like seatbelts and air bags. More recently, active safety features have been deployed that work to prevent an accident. Most active safety features are controlled by a CPU and include automatic braking, traction control, and electronic stability control.

### SUMMARY

The exemplary embodiments disclose a method, a structure, and a computer system for assessing a cognitive state of a driver of a vehicle. The exemplary embodiments may include collecting data from one or more sensors positioned around the vehicle and calculating a distraction value, an engagement value, and a workload value corresponding to the driver of the vehicle based on the data. The exemplary embodiments may further include determining whether the driver exhibits a low cognitive state based on the distraction value and the engagement value, and, based on determining that the driver exhibits the low cognitive state, assuming control of the vehicle.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a cognitive assessment system 100, in accordance with the exemplary embodiments.

FIG. 2 depicts an exemplary flowchart 200 illustrating the operations of a cognitive assessment program 132 of the cognitive assessment system 100, in accordance with the exemplary embodiments.

FIG. 3 depicts an example configuration of the vehicle 110 and the sensing devices 112, in accordance with the exemplary embodiments.

FIG. 4 depicts an example illustrating a mapping of the one or more sensing devices 112 and DEW components, in accordance with the exemplary embodiments.

FIG. 5 depicts an exemplary block diagram depicting the hardware components of the cognitive assessment system 100 of FIG. 1, in accordance with the exemplary embodiments.

FIG. 6 depicts a cloud computing environment, in accordance with the exemplary embodiments.

FIG. 7 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

Every year, the National Highway Traffic Safety Administration conducts crash tests on new vehicles and rates their performance in its 5-Star Safety Rating program. To pass this test, vehicle manufacturers equip cars with passive safety feature like seatbelts and air bags. More recently, active safety features have been deployed that work to prevent an accident. Most active safety features are controlled by a CPU and include automatic braking, traction control, and electronic stability control.

Full self-driving cars are not available yet. Current and near future technologies will require some form of driver intervention. It is important to monitor driver's cognitive state to either alert them or fine tune direct intervention (e.g., hard/soft braking, etc.). Currently, there are eye and head position tracking based solutions for detecting driver fatigue and attention, however they don't provide a comprehensive, multi-modal assessment of a driver's cognitive state.

The present invention evaluates a driver's cognitive state along three established dimensions: distraction, engagement, and workload (hereinafter collectively abbreviated by “DEW”). Distraction is a measure of diversion of one's attention from one mentally demanding task to another, in this case measured by evaluating the vehicle cabin environment for mentally demanding tasks aside from driving (e.g., noise, passengers, phone, etc.). Engagement is a measure of cognitive processing relating to information gathering and sensory processing, here measured by the interaction of the driver with the car (e.g., breaking, accelerating, steering, etc.). Lastly, workload is a measure of mental working and a level of cognitive processing related to central executive function, in this case measured by evaluating the environment outside the car (e.g., traffic, road condition, etc.). DEW is then used to inform a self-driving system to take action during emergencies or scenarios having low confidence in driver cognitive state.

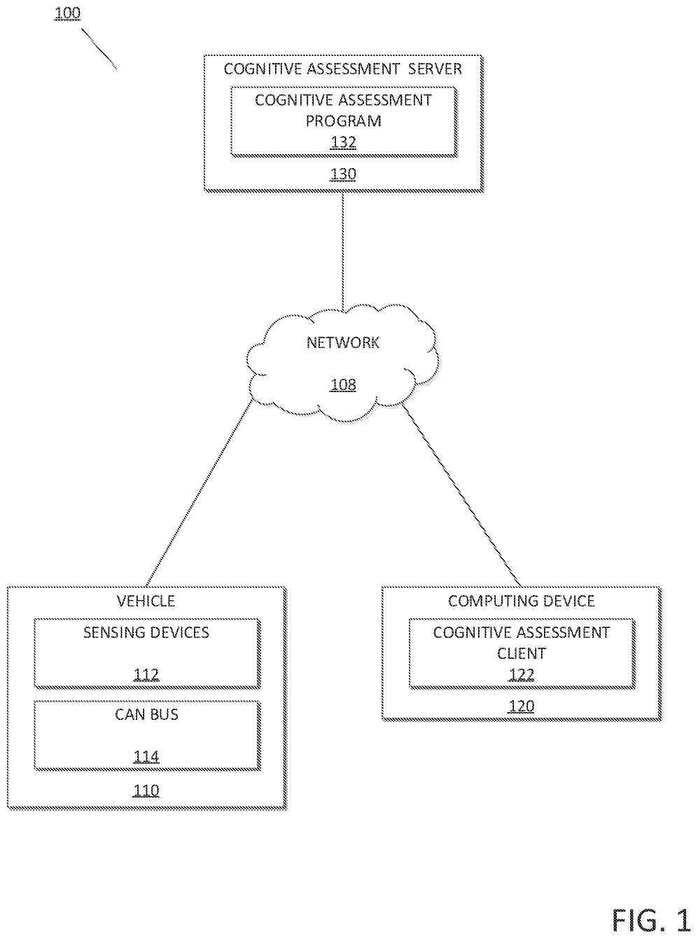

FIG. 1 depicts the cognitive assessment system 100, in accordance with exemplary embodiments. According to the exemplary embodiments, the cognitive assessment system 100 may include a vehicle 110, a computing device 120, and a cognitive assessment server 130, which all may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc., which may be implemented as an intranet network, a local area network (LAN), a wide area network (WAN), or a combination thereof. In further embodiments, the network 108 may be a Bluetooth network, a Wi-Fi network, or a combination thereof. The network 108 may operate in frequencies including 2.4 GHz and 5 GHz internet, near-field communication, Z-Wave, Zigbee, etc. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

In exemplary embodiments, the vehicle 110 may include one or more sensing devices 112 and a CAN bus 114, and may be any means of transport capable of moving one or more individuals, equipment, etc., from one location to another. In embodiments, the vehicle 110 requires at least some driver interaction in order to operate, for example changing gears with a gear shift, applying pressure to an accelerator, decelerator, or clutch pedal, turning a steering wheel, keeping hands on the steering wheel, etc. As will be described in greater detail, the vehicle 110 may communicate with the one or more sensing devices 112, and the collection of data and control of the vehicle 110 may be further based on data collected by the one or more sensing devices 112.

In exemplary embodiments, the sensing devices 112 may be one or more devices capable of collecting data, for example video data, audio data, activity/movement data, biometric data, etc. Accordingly, the sensing devices 112 may comprise mono/color cameras, infrared cameras, depth-sensing cameras/sensors, light detection and ranging (Lidar), proximity detectors, microphones, accelerometers, gyroscopes, pressure sensors, etc., capable of collecting color images, thermal images, object/environment depth, sound, velocity, acceleration, etc. In embodiments, the sensing devices 112 may be positioned within an environment of the vehicle 110 (e.g., mounted within a cabin), mounted on an exterior of the vehicle 110 (e.g., outward facing), worn by a driver (e.g., on the arms, hands, feet, legs, head, etc.), implantable, etc. The data collected by the sensing devices 112 may be transmitted to the vehicle 110 via direct integration therewith and/or transmitted to another device, e.g., the cognitive assessment server 130, via the network 108.

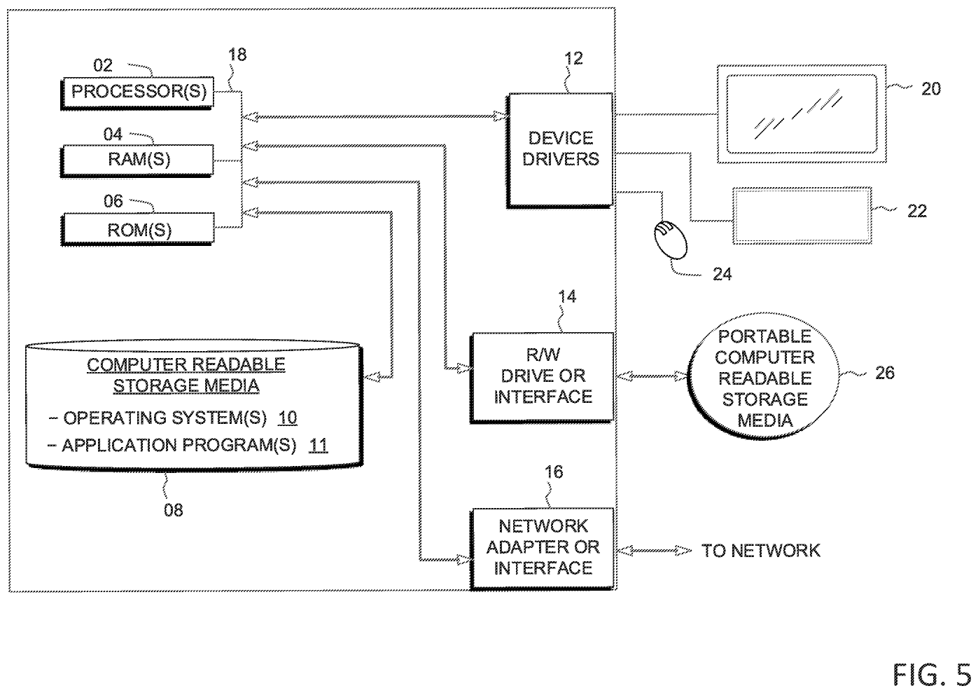

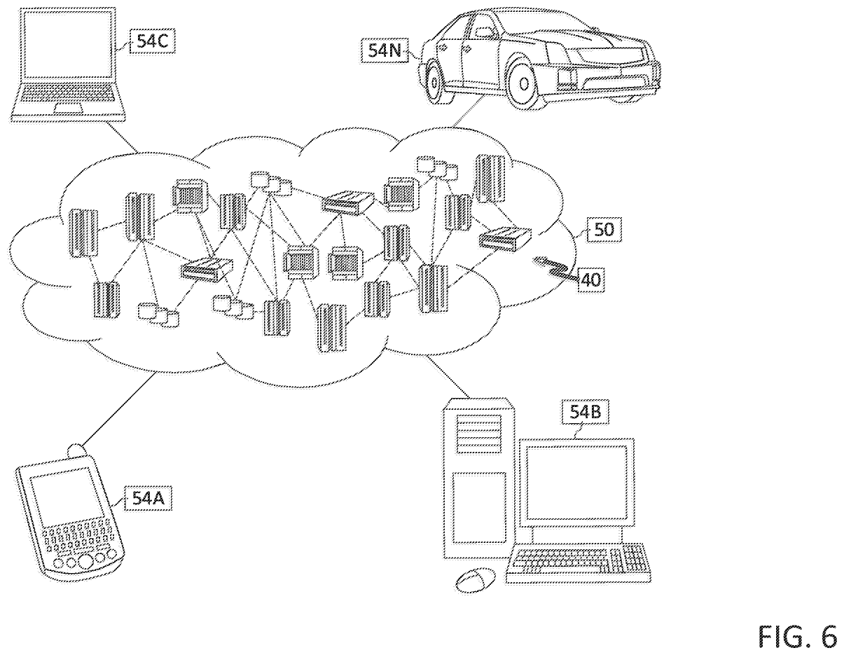

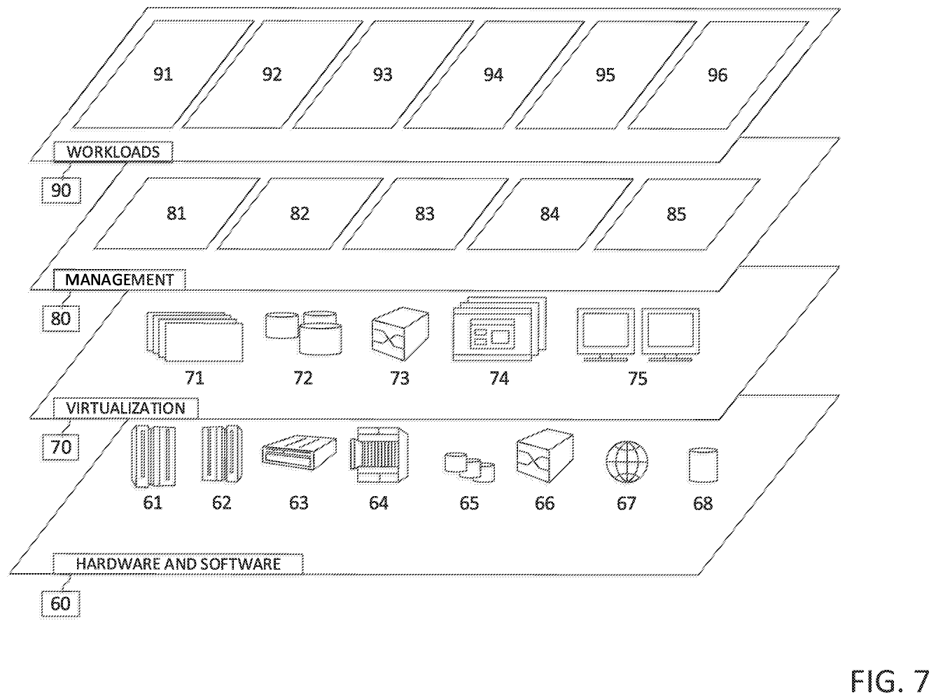

In exemplary embodiments, the Controller Area Network (CAN) Bus 114 may be a robust vehicle bus standard designed to allow microcontrollers and devices to communicate with each other's applications without a host computer. In embodiments, the CAN bus 114 allows for the monitoring and recording of vehicle 110 data, e.g., user interaction, vehicle 110 data, vehicle surroundings, etc. Moreover, the CAN bus 114 allows for control of the vehicle 110, e.g., accelerating, decelerating, turning, reducing radio volume, vibrating the steering wheel, etc. The CAN bus 114 is described in greater detail as a hardware implementation with reference to FIG. 5, as part of a cloud implementation with reference to FIG. 6, and/or as utilizing functional abstraction layers for processing with reference to FIG. 7.

In exemplary embodiments, the computing device 120 may include the cognitive assessment client 122, and may be an enterprise server, a laptop computer, a notebook, a tablet computer, a netbook computer, a personal computer (PC), a desktop computer, a server, a personal digital assistant (PDA), a smart phone, a mobile phone, a virtual device, a thin client, an IoT device, or any other electronic device or computing system capable of sending and receiving data to and from other computing devices. While the computing device 120 is shown as a single device, in other embodiments, the computing device 120 may be comprised of a cluster or plurality of computing devices, in a modular manner, etc., working together or working independently. The computing device 120 is described in greater detail as a hardware implementation with reference to FIG. 5, as part of a cloud implementation with reference to FIG. 6, and/or as utilizing functional abstraction layers for processing with reference to FIG. 7.

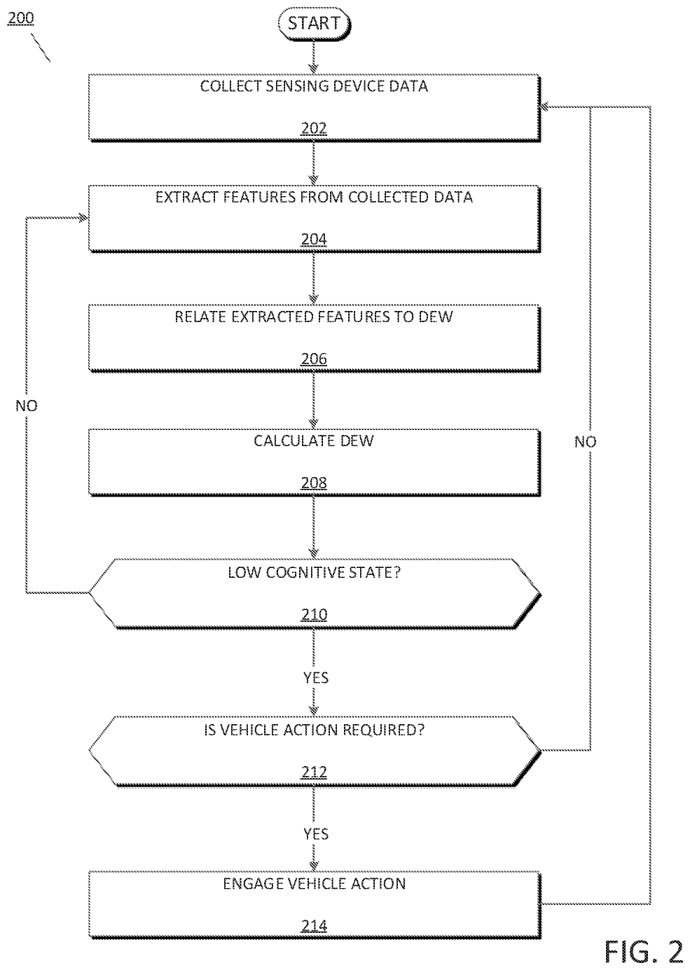

In exemplary embodiments, the cognitive assessment client 122 may act as a client in a client-server relationship with a server, for example the cognitive assessment server 130, and may be a software and/or hardware application capable of communicating with and providing a user interface for a user to interact with a server and other computing devices via the network 108. Moreover, in the example embodiment, the cognitive assessment client 122 may be capable of transferring data between the computing device 120 and other devices via the network 108. In embodiments, the cognitive assessment client 122 may utilize various wired and wireless connection protocols for data transmission and exchange, including Bluetooth, 2.4 GHz and 5 GHz internet, near-field communication, etc. The cognitive assessment client 122 is described in greater detail with respect to FIG. 2-7.

In exemplary embodiments, the cognitive assessment server 130 includes a cognitive assessment program 132, and may act as a server in a client-server relationship with a client, e.g., the cognitive assessment client 122. The cognitive assessment server 130 may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. While the cognitive assessment server 130 is shown as a single device, in other embodiments, the cognitive assessment server 130 may be comprised of a cluster or plurality of computing devices, in a modular manner, etc., working together or working independently. The cognitive assessment server 130 is described in greater detail as a hardware implementation with reference to FIG. 5, as part of a cloud implementation with reference to FIG. 6, and/or as utilizing functional abstraction layers for processing with reference to FIG. 7.

In embodiments, the cognitive assessment program 132 may be a software and/or hardware program that may collect sensing device data and extract features from the collected data. In addition, the cognitive assessment program 132 may be trained to relate the extracted features to distraction, engagement, and workload components, as well as calculate values for the distraction, engagement, and workload components using the trained relations. The cognitive assessment program 132 may determine whether a driver has a low cognitive state and, based thereon, whether any vehicle action is required. Based on determining that vehicle action is required, the cognitive assessment program 132 may engage vehicle action. The cognitive assessment program 132 is described in greater detail with reference to FIG. 2-7.

FIG. 2 depicts an exemplary flowchart 200 illustrating the operations of the cognitive assessment program 132 of the cognitive assessment system 100, in accordance with the exemplary embodiments.

The cognitive assessment program 132 may collect sensing device data (step 202). In embodiments, the cognitive assessment program 132 may collect sensing device data via reference to the sensing devices 112, and may do so on a continuous basis when the cognitive assessment program 132 determines that the vehicle 110 is being utilized. Such data may include, but is not limited to, video and audio of a driver and any passengers/cargo, video of a driver's eyes from an eye-tracking camera, steering wheel hand position/orientation/grip pressure, cabin/environment proximity sensor/lidar data, driver/passenger biometric data (e.g., from one or more wearable/implanted devices), vehicle data (e.g., safety features, etc.), vehicle speed/acceleration/location from GPS/CAN bus 114 data, etc. While most data is analysed in real time, the cognitive assessment program 132 may be configured to store the data for future reference. In addition, the cognitive assessment program 132 may store one or more profiles for one or more different drivers of the vehicle 110 such that different driving habits of different drivers can be captured. The cognitive assessment program 132 may further incorporate such driving habits into the cognitive assessment described in detail forthcoming.

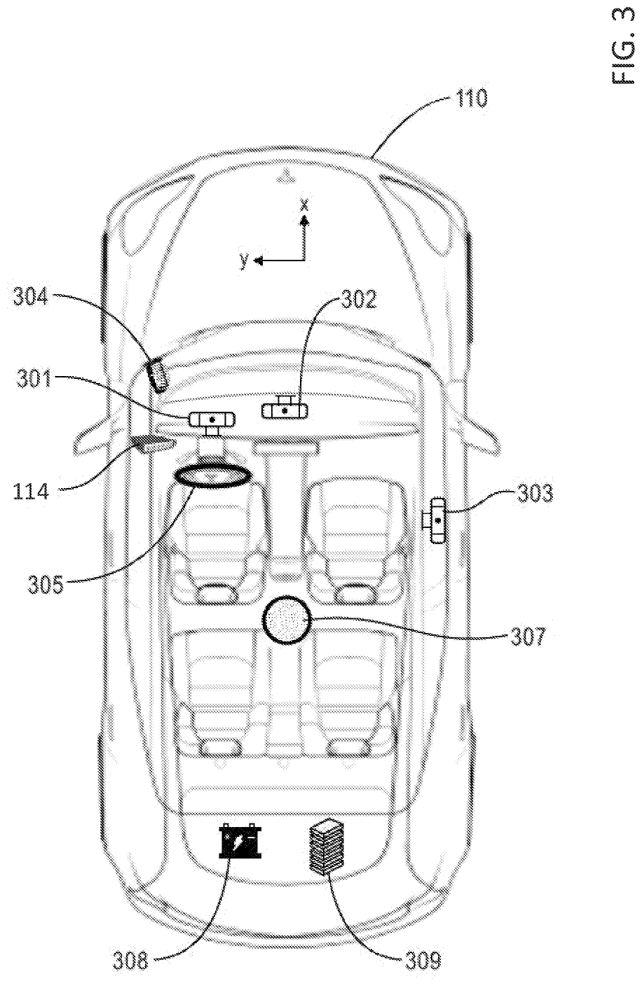

In order to better illustrate the operations of the cognitive assessment program 132, reference is now made to FIG. 3 depicting an example configuration of the vehicle 110 and the sensing devices 112, in accordance with the exemplary embodiments. As illustrated by FIG. 3, the vehicle 110 may be configured to include a cabin-facing dashboard camera 302, a cabin-facing passenger camera 303, one eye-tracking camera 301 above the steering wheel, a cabin microphone 304, a steering wheel-mounted grip sensor 305, a proximity sensor module 307, and a CAN bus 114. Also illustrated are a battery 308 and compute node 309 for any additional processing. In accordance with the example depicted by FIG. 3, data related to the driver and interior cabin of the vehicle 110 is detected using the cabin-facing dashboard camera 302, the cabin-facing passenger camera 303, the eye-tracking camera 301, the cabin microphone 304, and the steering wheel-mounted grip sensor 305. Meanwhile, data related to exterior environments and objects are detected by the proximity sensor module 307 in all directions using an array of lasers and detectors, e.g., lidar. In embodiments, the proximity sensor module 307 may additionally comprise an array of one or more video cameras in combination with the implemented light, radar, etc. technologies.

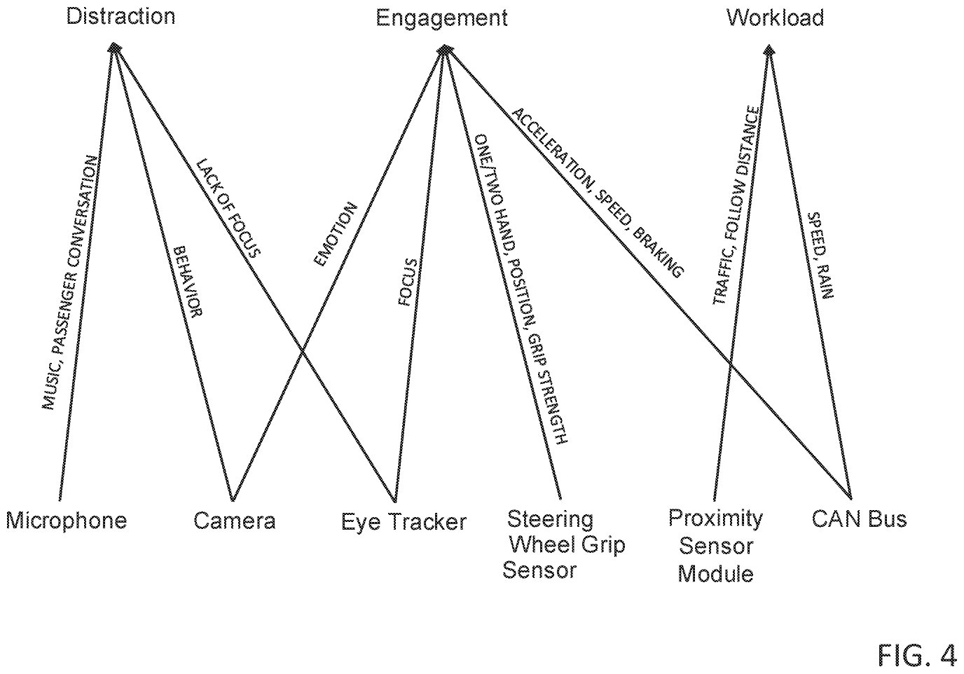

The cognitive assessment program 132 may extract features from the collected data (step 204). In embodiments, the cognitive assessment program 132 may extract features relating to determining a distraction, engagement, and workload. In particular, and with reference to FIG. 4, the cognitive assessment program 132 may extract from audio data captured with a microphone music and/or a driver engaging in conversation with oneself, on a phone, or with a passenger. In addition, the cognitive assessment program 132 may extract behaviour of a driver (e.g., looking at a smart phone) and emotion of a driver (e.g., happy, angry, sad, etc.) based on video data captured by cabin-facing cameras. Moreover, the cognitive assessment program 132 may extract a focus and lack thereof using video data captured by an eye-tracking camera. The cognitive assessment program 132 may further extract hand position(s), orientation(s), and grip pressure based on a steering wheel-mounted pressure sensor. What's more, the cognitive assessment program 132 may extract traffic, follow distance, and other objects based on proximity sensor data, as well as variations of acceleration, deceleration, speed, steering, rain, etc., based on CAN bus data. Lastly, the cognitive assessment program 132 may extract safety features and an overall level of automation of the vehicle 110 from the collected vehicle data to determine what existing autonomous capabilities the vehicle 110 has, if any.

Returning to the illustrative example introduced above, the cognitive assessment program 132 extracts that a driver is driving the vehicle 110 on a freeway based on CAN bus 114 data with the radio on and other passengers speaking as determined via data from the microphone 304 and the cabin-facing camera 302. Lastly, the cognitive assessment program 132 determines that there is a stationary anomaly in front of the vehicle based on data from the proximity sensor module 307.

The cognitive assessment program 132 may relate the extracted features to distraction, engagement, and workload (DEW) of a driver (step 206). Distraction is a measure of diversion of one's attention from one mentally demanding task to another, in this case measured by evaluating the vehicle cabin environment for mentally demanding tasks aside from driving (e.g., noise, passengers, phone, etc.). Engagement is a measure of cognitive processing relating to information gathering and sensory processing, here measured by the interaction of the driver with the car (e.g., breaking, accelerating, steering, etc.). Lastly, workload is a measure of mental working and a level of cognitive processing related to central executive function, in this case measured by evaluating the environment outside the car (e.g., traffic, road condition, etc.). In embodiments, the cognitive assessment program 132 may relate the features to DEW by associating the features with DEW values and/or weights using a rule-based approach, a machine learning approach, a combination of the two, etc. In particular, and with additional reference to FIG. 4, the cognitive assessment program 132 may relate distraction with the features of music, behaviour, and lack of focus. In addition, the cognitive assessment program 132 may relate engagement with the features of emotion, focus, hand position/orientation/grip strength, and variation of acceleration/speed/turning/etc. Lastly, the cognitive assessment program 132 may relate workload with the features of traffic, follow distance, speed, and rain.

For example, in a rule-based approach, reasonable assumptions may be used in configuring the cognitive assessment program 132 to assign one or more scores to DEW based on an existence or level of the one or more extracted features. For example, the cognitive assessment program 132 may assign a low distraction value to music within the cabin while assigning a high distraction value to passenger conversation within the cabin. Similarly, the cognitive assessment program 132 may assign high engagement values based on detection of high focus and emotion features. Moreover, the cognitive assessment program 132 may assign a high workload value based on detecting heavy traffic and close follow distance. In the rule-based approach described above, such reasonable assumptions may be made for each extracted feature and associated with a corresponding DEW value.

In other embodiments, the cognitive assessment program 132 may generate one or more models correlating the one or more extracted features with DEW using one or more machine learning models. In doing so, the cognitive assessment program 132 may utilize one or more machine learning algorithms, e.g., neural networks, for supervised/unsupervised training of a model based on one or more labelled/unlabelled sets of training data. In particular, and with continued reference to FIG. 4, the cognitive assessment program 132 may generate one or more models that capture an affect music, behaviour, and lack of focus have on distraction. In addition, the cognitive assessment program 132 may generate one or more models that capture an affect emotion, focus, hand position/orientation/grip strength, and variation of acceleration/speed/turning/etc. have on engagement. Lastly, the cognitive assessment program 132 may generate one or more models that capture an affect traffic, follow distance, speed, and rain have on workload.

In embodiments, the cognitive assessment program 132 may be configured to apply either or both of the above-described approaches, as well as any other known approaches to quantifying DEW values.

Furthering the previously introduced example, the cognitive assessment program 132 relates the extracted features to distraction, engagement, and workload components using a rule-based approach.

The cognitive assessment program 132 may calculate DEW component scores for a driver of the vehicle (step 208). In embodiments, the cognitive assessment program 132 may calculate DEW scores based on the determined relation between the extracted features and DEW. In particular, the cognitive assessment program 132 may apply the one or more rules and/or the one or more models to the extracted features in order to output a score indicative of each of the distraction, engagement, and workload components. In embodiments, the component scores may be binary or they may be continuous.

With reference again to the previously introduced example, the cognitive assessment program 132 applies one or more rules to the extracted features in order to calculate a score for each of distraction, engagement, and workload for the driver.

The cognitive assessment program 132 may determine whether the driver has a low cognitive driving state (decision 210). In embodiments, the cognitive assessment program 132 may determine whether the driver has a low cognitive state by assessing at least two of distraction, engagement, and workload in combination. Generally speaking, a high distraction score (e.g., a score above a predefined threshold or within a range) is an indication of a low cognitive driving state and vice versa. Conversely, a high engagement score is an indication of a high cognitive driving state and vice versa. Lastly, a high workload value indicates the need for a high cognitive driving state. Thus, based on the above assumptions, the cognitive assessment program 132 may be configured to determine a low cognitive driving state when a driver exhibits high distraction and low engagement scores. Conversely, the cognitive assessment program 132 may be configured to determine a high cognitive state when a driver exhibits low distraction and high engagement values. Each of the components may have respective thresholds that the DEW scores are then compared against and, e.g., should distraction exceed its threshold while engagement falls below its threshold, the cognitive assessment program 132 may identify the driving as having a low cognitive state.

Referring again to the previously introduced example, the cognitive assessment program 132 determines that the driver has high distraction and low engagement scores based on comparisons to respective thresholds, and therefore determines that the driver has a low cognitive state.

If the cognitive assessment program 132 determines that the driver has a low cognitive driving state (decision 210, “YES” branch), then the cognitive assessment program 132 determines whether vehicle action is required (decision 212). In embodiments, the cognitive assessment program 132 may determine vehicle action is required based on data collected by the proximity sensing module 307 and the computed workload component. The workload component describes a need for a high cognitive state of the driver, and may be based on features such as stop and go traffic, close follow distance, collision detection, lane departure, and other driving hazards. Based on any of the aforementioned features, or the overall workload component score, the cognitive assessment program 132 may determine that vehicle action is required. In embodiments, the aforementioned step of determining whether vehicle action is required may be omitted and control of the vehicle 110 may be assumed by the cognitive assessment program 132 as soon as it is determined that a driver has a low cognitive state. Thus, in such embodiments, determining whether vehicle action is required may be inconsequential and the cognitive assessment program 132 may assume control as soon as it is determined that a driver exhibits a low cognitive state.

Returning to the previously-introduced example, the cognitive assessment program 132 determines that vehicle action is needed based on the driver exhibiting a low cognitive driving state and the detection of an anomaly in the freeway.

If the cognitive assessment program 132 determines that vehicle action is required (decision 212, “YES” branch), then the cognitive assessment program 132 engages in the required vehicle action (step 214). In embodiments, the cognitive assessment program 132 takes action via the CAN bus 114 in order to assume control of the vehicle 110, and may do so in order to stop, stay in lane, avoid any objects or environmental hazards, etc. Such actions may include acceleration, deceleration, steering, sending a notification to a driver (e.g., vibration of a seat/steering wheel, flashing lights on dashboard, turning down/off radio, audible alerts, etc.). In embodiments, the cognitive assessment program 132 may be configured to immediately but safely pull over to a safe location, while in others actions may be taken while efforts are made to increase cognition of the driver through audio, visual, or physical hints mentioned above. In yet further embodiments where an extremely low cognitive state of a driver is assessed, the cognitive assessment program 132 may be configured to deliver the driver to a closest medical facility or hospital identified via, e.g., the network 108.

In concluding the previously introduced example, the cognitive assessment program 132 engages vehicle action to avoid a collision by decelerating and turning the vehicle, as well as alerting the driver by turning down the radio and vibrating the steering wheel.

FIG. 4 depicts an example illustrating a mapping of the one or more sensing devices 112 and DEW components, in accordance with the exemplary embodiments.

FIG. 5 depicts a block diagram of devices used within the cognitive assessment system 100 of FIG. 1, in accordance with the exemplary embodiments. It should be appreciated that FIG. 5 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 40 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfilment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cognitive assessment processing 96.

The exemplary embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for assessing a cognitive state of a driver of a vehicle, the method comprising:
collecting data from one or more sensors positioned around the vehicle;
calculating a distraction value, an engagement value, and a workload value corresponding to the driver of the vehicle based on the data;
determining whether the driver exhibits a low cognitive state based on the distraction value and the engagement value; and
based on determining that the driver exhibits the low cognitive state, assuming control of the vehicle.

2. The method of claim 1, further comprising:
determining whether vehicle action is required based on the workload value; and
based on determining that the vehicle action is required, taking the required vehicle action via communication with the vehicle.

3. The method of claim 2, wherein the required vehicle action is selected from a group comprising turning, accelerating, decelerating, and alerting the driver.

4. The method of claim 1, wherein determining whether the driver exhibits the low cognitive state further comprises:
extracting one or more features from the data; and
at least one of:
training a machine learning model based on training data; and
applying the machine learning model to the extracted features; or
applying a rule-based model to the features.

5. The method of claim 1, wherein the one or more sensors comprise at least one of a microphone and a camera, and wherein calculating the distraction value is based on the data collected from the microphone and the camera.

6. The method of claim 1, wherein the one or more sensors comprise at least one of an eye tracking camera and a steering wheel grip sensor, and wherein calculating the engagement value is based on the data collected from the eye tracking camera and the steering wheel grip sensor.

7. The method of claim 1, wherein the one or more sensors comprise a proximity sensor, and wherein calculating the workload value is based on the data collected from the proximity sensor and communication with the vehicle.

8. A computer program product for assessing a cognitive state of a driver of a vehicle, the computer program product comprising:
one or more computer-readable storage media and program instructions stored on the one or more computer-readable storage media, the program instructions including a method, the method comprising:
collecting data from one or more sensors positioned around the vehicle;
calculating a distraction value, an engagement value, and a workload value corresponding to the driver of the vehicle based on the data;
determining whether the driver exhibits a low cognitive state based on the distraction value and the engagement value; and
based on determining that the driver exhibits the low cognitive state, assuming control of the vehicle.

9. The computer program product of claim 8, further comprising:
determining whether vehicle action is required based on the workload value; and
based on determining that the vehicle action is required, taking the required vehicle action via communication with the vehicle.

10. The computer program product of claim 9, wherein the required vehicle action is selected from a group comprising turning, accelerating, decelerating, and alerting the driver.

11. The computer program product of claim 8, wherein determining whether the driver exhibits the low cognitive state further comprises:
extracting one or more features from the data; and
at least one of:
training a machine learning model based on training data; and
applying the machine learning model to the extracted features; or
applying a rule-based model to the features.

12. The computer program product of claim 8, wherein the one or more sensors comprise at least one of a microphone and a camera, and wherein calculating the distraction value is based on the data collected from the microphone and the camera.

13. The computer program product of claim 8, wherein the one or more sensors comprise at least one of an eye tracking camera and a steering wheel grip sensor, and wherein calculating the engagement value is based on the data collected from the eye tracking camera and the steering wheel grip sensor.

14. The computer program product of claim 8, wherein the one or more sensors comprise a proximity sensor, and wherein calculating the workload value is based on the data collected from the proximity sensor and communication with the vehicle.

15. A computer system for assessing a cognitive state of a driver of a vehicle, the computer system comprising:
one or more computer processors, one or more computer-readable storage media, and program instructions stored on one or more of the computer-readable storage media for execution by at least one of the one or more processors, the program instructions including a method, the method comprising:
collecting data from one or more sensors positioned around the vehicle;
calculating a distraction value, an engagement value, and a workload value corresponding to the driver of the vehicle based on the data;
determining whether the driver exhibits a low cognitive state based on the distraction value and the engagement value; and
based on determining that the driver exhibits the low cognitive state, assuming control of the vehicle.

16. The computer system of claim 15, further comprising:
determining whether vehicle action is required based on the workload value; and
based on determining that the vehicle action is required, taking the required vehicle action via communication with the vehicle.

17. The computer system of claim 16, wherein the required vehicle action is selected from a group comprising turning, accelerating, decelerating, and alerting the driver.

18. The computer system of claim 15, wherein determining whether the driver exhibits the low cognitive state further comprises:
extracting one or more features from the data; and
at least one of:
training a machine learning model based on training data; and
applying the machine learning model to the extracted features; or
applying a rule-based model to the features.

19. The computer system of claim 15, wherein the one or more sensors comprise at least one of a microphone and a camera, and wherein calculating the distraction value is based on the data collected from the microphone and the camera.

20. The computer system of claim 15, wherein the one or more sensors comprise at least one of an eye tracking camera and a steering wheel grip sensor, and wherein calculating the engagement value is based on the data collected from the eye tracking camera and the steering wheel grip sensor.
